(19) United States
(12) Patent Application Publication
(10) Pub. No.: US 2016/0297668 A1
(43) Pub. Date: Oct. 13, 2016

(54) UNDERGROUND AUTOGAS DISPENSING TANK

(71) Applicant: James C. Roberts, Wills Point, TX (US)

(72) Inventor: James C. Roberts, Wills Point, TX (US)

(21) Appl. No.: 14/681,588

(22) Filed: Apr. 8, 2015

(51) Int. Cl. B67D 7/04; B67D 7/78; B67D 7/58

(52) U.S. Cl. CPC B67D 7/0478; B67D 7/58; B67D 7/78

(57) ABSTRACT

According to one embodiment, a liquid dispensing system includes a liquid storage tank comprising a pressure chamber with a liquid space and a vapor space. The liquid storage tank further comprises a liquid bypass riser comprising a first end in communication with the vapor space, and a second end exterior to the pressure chamber. The liquid bypass riser forms a first passageway to the vapor space for returning liquid to the pressure chamber. The liquid storage tank further comprises a vapor return riser located within an interior portion of the liquid bypass riser. The vapor return riser comprises a first end located in the vapor space and a second end exterior to the pressure chamber. It forms a second passageway to the vapor space of the pressure chamber. The second passageway prevents liquid in the first passageway from entering the second passageway.

### TECHNICAL FIELD

This disclosure generally relates to liquid storage tanks, and more particularly to underground autogas dispensing tanks.

### BACKGROUND

Propane autogas is a widely used alternative transportation fuel. Operators of autogas powered vehicles refuel using autogas dispensing systems found at refueling facilities such as service stations, truck stops, fleet-maintenance facilities, and propane sales outlets.

A conventional autogas dispensing system includes a liquid storage tank for storing fuel and a dispenser unit for transferring the fuel to a vehicle. Conventional autogas dispensing systems use standard above ground propane tanks for storing liquid propane.

A standard above ground tank's bottom portion (the liquid space) includes one 1.25 inch liquid opening for dispensing propane. A standard above ground tank's top portion (the vapor space) includes one 1.25 inch vapor opening and one 1.25 inch liquid withdrawal opening. The liquid withdrawal opening is attached to a diptube that extends towards the bottom of the tank in direct communication with the liquid space of the propane tank. Propane supply companies typically use the liquid withdrawal opening to empty the liquid propane before transporting a tank. When filling a propane tank, a propane supplier typically connects a vapor recovery hose from the supply truck to the vapor opening of the propane tank. When installed as part of an autogas dispensing system, the liquid opening, the vapor opening, and the liquid withdrawal opening of a standard above ground propane tank are connected, directly or indirectly, to the dispenser unit.

An above ground tank is typically located near the autogas dispenser and consumes surface real estate at the refueling facility. A refueling facility typically includes barriers to protect the tank, dispenser, and any exposed piping from contact with hazards, such as vehicle traffic at the refueling facility.

### SUMMARY

According to one embodiment, a liquid dispensing system includes a liquid storage tank comprising a pressure chamber comprising a liquid space located at a bottom interior portion of the pressure chamber and a vapor space located at a top interior portion of the pressure chamber. The liquid storage tank further comprises a liquid bypass riser comprising a first end coupled to the top of the pressure chamber and in communication with the vapor space of the pressure chamber and a second end located exterior to the pressure chamber. The liquid bypass riser forms a first passageway to the vapor space of the pressure chamber for returning liquid to the pressure chamber. The liquid storage tank further comprises a vapor return riser located within an interior portion of the liquid bypass riser. The vapor return riser comprises a first end located in the vapor space of the pressure chamber and a second end located exterior to the pressure chamber. It forms a second passageway to the vapor space of the pressure chamber. The second passageway is configured to prevent a liquid in the first passageway from entering the second passageway. The system also includes a liquid dispenser configured to dispense liquid into an external storage tank wherein the liquid bypass riser is coupled to a liquid bypass port of the liquid dispenser, and the vapor return riser is coupled to a vapor return port of the liquid dispenser.

In particular embodiments, the liquid storage tank comprises a liquid supply riser comprising a first end located in the liquid space of the pressure chamber and a second end located exterior to the pressure chamber. The liquid supply riser forms a passageway from the liquid space of the pressure chamber. The liquid supply riser is coupled to a liquid supply inlet port of the liquid dispenser.

Certain embodiments may provide one or more technical advantages. In some embodiments, an underground tank may conserve surface real estate and provide protection from particular hazards, such as vehicle traffic. An underground tank may reduce the need for particular above ground safety barriers.

In particular embodiments, a nested liquid bypass riser and vapor return riser reduces the effective number of risers extending from an underground tank, which can reduce manufacturing and installation costs.

In particular embodiments, nesting a smaller vapor return riser within a larger liquid bypass riser provides additional support for the vapor return riser. A sturdier riser may facilitate a riser installation outside of a housing dome, which provides for flexible tank configurations and installation options.

In some embodiments, a liquid bypass riser in communication with a tank's vapor space allows bypass liquids to return to the vapor space of the tank. Returning bypass liquids to the vapor space produces less back pressure on a pump than returning bypass liquids to the liquid space.

Another advantage of some embodiments is that an approximately two inch diameter liquid supply riser supplies sufficient liquid to meet the supply requirements of a high capacity propane pump. The ability to use a high capacity propane pump decreases refueling time for autogas propane vehicles with large fuel tanks such as buses and trucks. In particular embodiments, an approximately three inch diameter portion at the top of the liquid supply riser enables more propane to flow to a pump valve located in the top portion of the liquid supply riser.

As a result, particular embodiments of the present disclosure may provide numerous technical advantages. Particular embodiments of the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1 is an example autogas dispensing system, in accordance with particular embodiments;

FIG. 2A is a cross-sectional side view of an underground autogas dispensing tank, in accordance with particular embodiments;

FIG. 2B is a cross-sectional end view of an underground autogas dispensing tank, in accordance with particular embodiments; and

FIG. 2C is another cross-sectional end view of an underground autogas dispensing tank, in accordance with particular embodiments.

### DETAILED DESCRIPTION

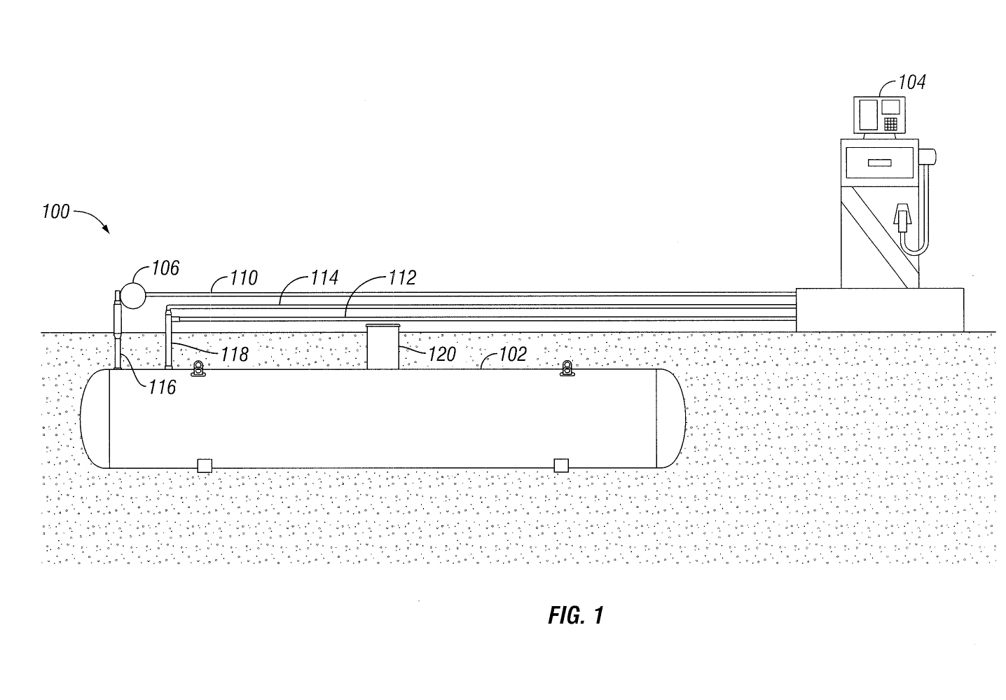

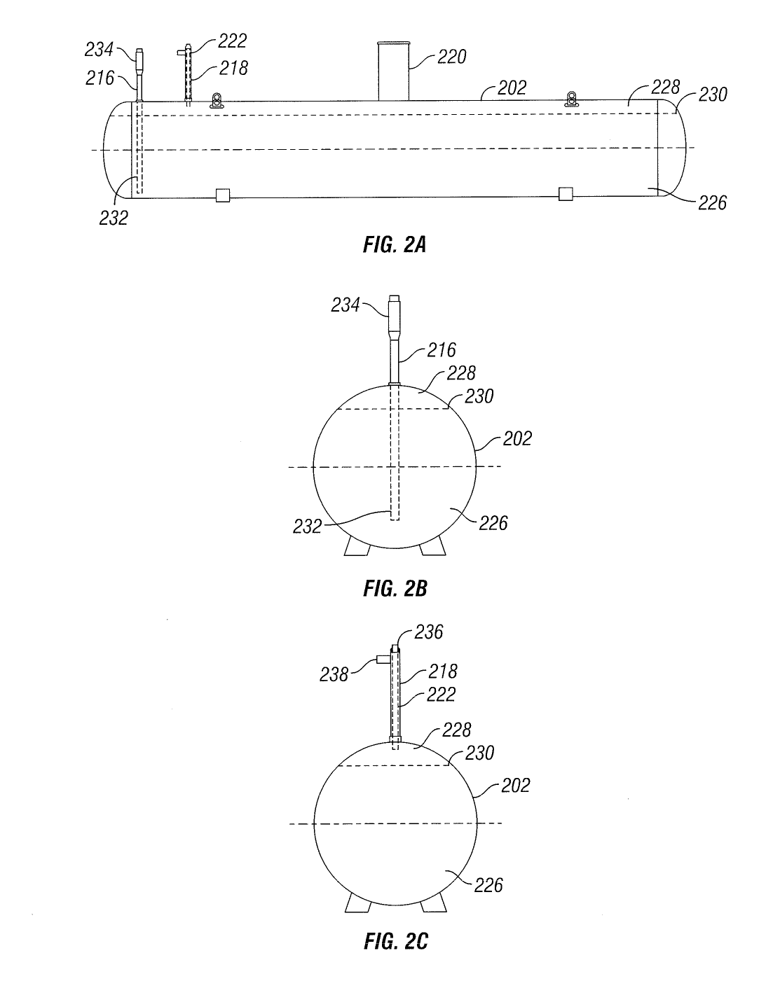

Particular embodiments and their advantages are best understood by reference to FIGS. 1-2C wherein like reference numbers indicate like features.

FIG. 1 is an example autogas dispensing system, in accordance with particular embodiments. FIG. 1 illustrates autogas dispensing system 100 comprising tank 102, dispenser 104, pump 106, liquid supply riser 116, liquid bypass riser 118, housing dome 120, liquid supply pipe 110, liquid bypass pipe 112, and vapor return pipe 114. In particular embodiments, autogas dispensing system 100 may dispense autogas propane for refueling autogas powered vehicles.

Tank 102 is a pressure chamber for storing liquid. Tank 102 may be constructed of any material suitable for containing the liquid commodity stored within tank 102 and also suitable for burial at least partially underground.

In particular embodiments, tank 102 may store autogas propane. Various national, state, and local agencies publish rules and specifications for construction of underground propane tanks intended for use within the United States. In particular embodiments, tank 102 and other underground components of system 100 comprise a protective coating to prevent corrosion.

Dispenser 104 transfers a liquid stored in tank 102 to an external storage container, such as a vehicle fuel storage container. Dispenser 104 may comprise components for metering and displaying the amount of liquid dispensed. Dispenser 104 may comprise components for receiving and transmitting payment information. In particular embodiments, dispenser 104 may dispense autogas propane to autogas propane fueled vehicles.

Pump 106 pumps liquid from tank 102 to dispenser 104 through liquid supply riser 116 and liquid supply pipe 110. The size and rating of pump 106 may be determined according to the pressure and volume requirements of dispenser 104. For example, a 2-hose dispenser 104 may require different pressure and volume than a 1-hose dispenser 104. In addition, the size of liquid supply riser 116 and liquid supply pipe 110 determines, in part, the pressure and volume pump 106 is able to produce. In particular embodiments, pump 106 may be a turbine, gear, vane, or any suitable pump type for pumping the liquid commodity stored in tank 102. In particular embodiments, pump 106 is a liquid propane pump.

Liquid supply riser 116 extends from a bottom portion of the interior of tank 102, at one end, through a top portion of tank 102, and to near ground level at the other end. In particular embodiments, the top portion of liquid supply riser 116 is coupled to pump 106. Liquid supply riser 116 supplies liquid, such as liquid propane, from tank 102 to pump 106 and on to dispenser 104.

In particular embodiments, the top portion of liquid supply riser 116 extends a few inches above ground level. In other embodiments, the top portion of liquid supply riser 116 may extend higher or lower above or near ground level to accommodate terrain, climate (e.g., water, ice, snow, etc.) or any other site-specific factors.

Liquid bypass riser 118, at one end, is coupled to the top portion of tank 102 and the other end extends to near ground level. A top portion of liquid bypass riser 118 is coupled to liquid bypass pipe 112 which is in turn coupled to a liquid bypass port of dispenser 104, a portion of liquid supply pipe 110 between pump 106 and dispenser 104, or any other suitable location to provide liquid recirculation between dispenser 104 and tank 102.

In particular embodiments, the top portion of liquid bypass riser 118 extends a few inches above ground level. In other embodiments, (similar to liquid supply riser 116) the top portion of liquid bypass riser 118 may extend higher or lower above or near ground level to accommodate any site-specific factors.

Vapor return pipe 114 is coupled to a vapor return port of dispenser 104 at one end and a vapor return riser (not illustrated) housed within liquid bypass riser 118 at the other end. The vapor return riser housed within liquid bypass riser 118 is illustrated in FIGS. 2A and 2C and described in more detail below. Vapor return pipe 114 returns vapor from dispenser 104 to tank 102.

Housing dome 120 is coupled to the top portion of tank 102 and extends to near or above ground level. Housing dome 120 provides a protective housing for various risers, valves (e.g., pressure relief valve), meters, etc.

Particular embodiments may include more than one housing dome. In particular embodiments, one or more of liquid supply riser 116 and liquid bypass riser 118 may be located outside of a housing dome. In other embodiments, such as where required by regulation for example, one or more of liquid supply riser 116 and liquid bypass riser 118 may be located within one or more housing domes 120.

Flexibility in locating liquid supply riser 116 and liquid bypass riser 118 provides several advantages. In particular embodiments, housing dome 120 may be located in a position where the meters and valves contained within are easily accessible to a technician. The location of housing dome 120, however, may not be an optimal location for liquid supply riser 116 or liquid bypass riser 118. Liquid supply riser 116 and liquid bypass riser 118 may be located outside housing dome 120 in an advantageous position relative to dispenser 104. For example, in some embodiments liquid supply riser 116 and liquid bypass riser 118 may be located near dispenser 104 to minimize exposed piping. In other embodiments, liquid supply riser 116 may be positioned farther away from other components of system 100 to increase the length of liquid supply pipe 110 because longer lengths of supply pipe allow for greater dissipation of air bubbles.

In an example of operation of a particular embodiment, an autogas propane powered vehicle operator may stop to refuel the vehicle at autogas dispensing system 100. The operator may connect a hose end valve of dispenser 104 to a vehicle filler valve coupled to the vehicle's autogas propane storage tank. The operator may activate dispenser 104 by a lever activated handle coupled to the hose end valve. Upon activation of dispenser 104, pump 106 may deliver liquid propane through liquid supply riser 116 and liquid supply pipe 110 to dispenser 104 and to the operator's vehicle. Liquid bypass pipe 112 may return any excess liquid back to tank 102 through liquid bypass riser 118. Vapor return pipe 114 may return any vapor from dispenser 104 to tank 102 through the vapor return riser located within liquid bypass riser 118.

In particular embodiments, autogas dispensing system 100 may dispense liquids that may be flammable or volatile under certain conditions. National, state, and local codes may specify safety measures for installation of autogas dispensing system 100 at locations such as service stations, truck stops, fleet-maintenance facilities, or propane sales outlets. For example, safety measures may include installation of concrete post barriers to prevent a vehicle from contacting components of autogas dispensing system 100. Protecting components of autogas dispensing system 100 from vehicle contact or other undesirable contact is thus an advantageous safety feature. A particular advantage of locating components of system 100, such as tank 102, underground is that the underground location may protect components from undesirable contact.

FIG. 2A is a cross-sectional side view of an underground autogas dispensing tank, in accordance with particular embodiments. FIG. 2A illustrates tank 202, similar to tank 102 described above in reference to FIG. 1.

Tank 202 comprises liquid supply riser 216, liquid bypass riser 218, vapor return riser 222, and housing dome 220. In particular embodiments, tank 202 may comprise a 1,000 water gallon tank, a 2,000 water gallon tank, or any size tank suitable for dispensing autogas propane. In particular embodiments, a 2,000 water gallon tank may perform efficiently when used with a high volume pump.

The contents of tank 202 may comprise a liquid phase commodity 226 located in a bottom portion of tank 202 (below dotted line 230) and a gaseous vapor phase commodity 228 located above liquid commodity 226 in an upper portion of tank 202 (above dotted line 230). In particular embodiments, liquid phase commodity 226 comprises liquid propane and vapor phase commodity 228 comprises propane vapor.

National, state, and local agencies may publish rules and specifications regarding the maximum percentage of tank 202 that liquid phase commodity 226 may occupy. In particular embodiments, regulations may limit liquid phase commodity 226 to no more than 80% of tank 202 capacity.

Liquid supply riser 216 forms a passageway from the liquid space of tank 102 and facilitates transfer of liquid phase commodity 226 out of tank 202. Bottom end 232 of liquid supply riser 216 is located in the liquid space near the bottom interior of tank 102. In particular embodiments, liquid supply riser 216 may comprise a 2 inch diameter pipe. In some embodiments, liquid supply riser 216 may comprise a pipe greater than 2 inches in diameter. In particular embodiments, liquid supply riser 216 may comprise any size or style piping suitable for transferring liquid phase commodity 226 out of tank 202.

In particular embodiments, top portion 234 of liquid supply riser 216 may comprise a portion of approximately 3 inches in diameter. Top portion 234 may house portions of pump 106, such as an inlet valve. In particular embodiments, an advantage of the enlarged portion of liquid supply riser 216 is that it enables a greater volume of liquid to flow around and into the pump valve.

In the embodiment illustrated, liquid supply riser 216 is located at a particular location near one end of tank 202. In other embodiments, liquid supply riser 216 may be located at any suitable location along the length of tank 202.

Traditional above ground propane tanks comprise a liquid supply opening 1.25 inches in diameter. A liquid supply opening of 1.25 inches may not supply sufficient liquid flow to a high capacity pump, such as pump 106. A particular advantage of the current disclosure, according to particular embodiments, is that an approximately 2 inch diameter liquid supply riser may supply sufficient liquid flow to a high capacity pump, which thereby decreases the time for refueling vehicles with large fuel storage tanks.

Liquid bypass riser 218 forms a passageway to the vapor space (the space occupied by vapor phase commodity 228) of tank 102 and facilitates transfer of liquid phase commodity 226 into tank 202. In particular embodiments, liquid bypass riser 218 may comprise an approximately 2 inch diameter pipe. In some embodiments, liquid bypass riser 218 may comprise a pipe greater than 2 inches in diameter. In particular embodiments, liquid bypass riser 218 may comprise any size or style piping suitable for transferring liquid phase commodity 226 into tank 202.

A particular advantage of locating liquid bypass riser 218 in communication with the vapor space of tank 102 is that pumping a recirculated liquid into the vapor space of tank 202 creates less back pressure on pump 106 than if pump 106 pumped the recirculated liquid into the liquid space of tank 202.

In the embodiment illustrated, liquid bypass riser 218 is located at a particular location near one end of tank 202. In other embodiments, liquid bypass riser 218 may be located at any suitable location along the length of tank 202.

Vapor return riser 222 forms a passageway to the vapor space of tank 102 and facilitates transfer of vapor phase commodity 228 into tank 202. In particular embodiments, vapor return riser 222 may comprise an approximately 1.25 inch diameter pipe. In particular embodiments, liquid bypass riser 218 may comprise any size or style piping suitable for transferring vapor phase commodity 228 into tank 202.

Vapor return riser 222 is located within liquid return riser 218. Vapor return riser 222 and liquid return riser 218 form concentric passageways where the inner passageway (formed by vapor return riser 222) transports vapor phase commodity 228 into the vapor space of tank 202 and the outer passageway (formed by the portion of the interior of liquid bypass riser 218 not occupied by vapor return riser 222) transports liquid phase commodity 226 into the vapor space of tank 202. The configuration of the concentric passageways prevents liquid phase commodity 226 from entering vapor return riser 222 and vapor return pipe 114.

The concentric configuration of liquid bypass riser 218 and vapor return riser 222 is advantageous because it reduces the effective number of risers extending from tank 202. Additionally, housing smaller diameter vapor return riser 222 within larger diameter liquid bypass riser 218 provides increased structural support for vapor return riser 222. Thus, in particular embodiments, liquid bypass riser 218 and vapor return riser 222 may be located outside housing dome 220.

As described above, vapor return riser 222 may comprise an approximately 1.25 inch diameter pipe. In particular embodiments, vapor return riser 222 may comprise any diameter pipe sized to fit within liquid bypass riser 218 without restricting the required flow of liquid within liquid bypass riser 218.

One of skill in the art will realize that other configurations are possible. For example, in particular embodiments an inner passageway may transport liquid phase commodity 226 and an outer passageway may transport vapor phase commodity 228.

FIG. 2B is a cross-sectional end view of an autogas dispensing tank, in accordance with particular embodiments. FIG. 2B illustrates tank 202 and liquid supply riser 216 similar to like numbered elements described above in reference to FIGS. 1 and 2A.

Bottom end 232 of liquid supply riser 216 is located in the liquid space near the bottom interior of tank 102. In particular embodiments, bottom end 232 is located approximately 2 inches above the bottom interior wall of tank 202. In other embodiments, bottom end 232 is located at a suitable distance from the bottom interior wall of tank 202 determined by the size of tank 202 and the properties of a particular liquid phase commodity 226.

Liquid supply riser 216 extends through a top portion of tank 202 to top end 234. In particular embodiments, liquid supply riser 216 may comprise a single pipe. Liquid supply riser 216 may be welded to tank 202 at the portion where liquid supply riser 216 passes through tank 202. In some embodiments, liquid supply riser may comprise multiple sections of pipe. For example, a portion of liquid supply riser 216 interior to tank 202 may be welded to a threaded opening located on a top portion of tank 202. Another portion of liquid supply riser 216 may attach to the threaded opening and extend towards ground level.

In particular embodiments, top end 234 of liquid supply riser 216 may comprise a larger diameter than bottom end 232. As described with respect to FIG. 1, top end 234 may house components of pump 106.

FIG. 2C is another cross-sectional end view of an autogas dispensing tank, in accordance with particular embodiments. FIG. 2C illustrates tank 202, liquid bypass riser 218, and vapor return riser 222 similar to like numbered elements described above in reference to FIGS. 1 and 2A.

Liquid return riser 218 and vapor return riser 222 form concentric passageways in communication with the vapor space of tank 202. Liquid return riser 218 comprises top end 236 and opening 238.

In particular embodiments, top end 236 of liquid bypass riser 218 comprises an end cap for coupling vapor return riser 222 to liquid bypass riser 218. In particular embodiments, the end cap comprises a 1.25 inch threaded opening for coupling, for example, vapor return pipe 114 to vapor return riser 222. In particular embodiments, the end cap may we welded to liquid bypass riser 218. In particular embodiments, the end cap may comprise any suitable configuration for coupling vapor return riser 222 to liquid bypass riser 218. In other embodiments, vapor return riser 222 may be coupled to an opening in a side wall of liquid bypass riser 218.

In particular embodiments, vapor return riser 222 may be coupled to liquid bypass riser 218 at top end 236 and the bottom end of vapor return riser 222 extends into the vapor space of tank 202. In particular embodiments, the bottom end of vapor return riser 222 extends approximately 2 inches into the vapor space of tank 202. In other embodiments, the bottom end of vapor return riser 222 extends any suitable distance into the vapor space of tank 202.

In particular embodiments, vapor return riser 222 is coupled to liquid bypass riser 218 at top portion 236 and suspended within liquid bypass riser 218. In particular embodiments, vapor return riser 222 may be coupled to liquid bypass riser 218 at other locations, such as by support rods or any other suitable configuration that does not interfere with the required flow of liquid in liquid bypass riser 218. Although vapor return riser 222 is illustrated centered within liquid bypass riser 218, in particular embodiments, vapor return riser 222 may be offset from center. For example, vapor return riser 222 may be coupled to an interior side wall of liquid bypass riser 218.

Another advantage of housing vapor return riser 222 within liquid bypass riser 218 is that vapor return riser 222 may not be in contact with the soil. Thus, vapor return riser 222 may comprise material without anti-corrosive properties. In particular embodiments, vapor return riser 222 comprises any material compatible with liquid phase commodity 226. In particular embodiments, vapor return riser 222 may comprise flexible tubing. A particular advantage is that vapor return riser may decrease manufacturing expenses.

Opening 238 comprises an opening for coupling liquid bypass pipe 112 to liquid bypass riser 218. In particular embodiments, opening 238 may comprise a 2 inch threaded opening. In particular embodiments, opening 238 may comprise any opening suitable for coupling piping, such a liquid bypass pipe 112, to liquid bypass riser 218. Although opening 238 is illustrated at a particular location, opening 238 may be positioned at any suitable location on liquid bypass riser 218.

Although embodiments of the present disclosure and their advantages have been described in detail, it should be understood that various changes, substitutions and alterations can be made herein without departing from the spirit and scope of the invention as defined by the following claims. For example, although the figures illustrate various locations of openings, risers, and piping, various embodiments contemplate flexibility in the configuration of the various components with respect to each other, the tank, and the dispenser. Various couplings may include additional valves not illustrated. Additionally, while the disclosure describes certain embodiments with respect to an autogas propane dispensing system, particular embodiments may be used for a variety of liquid dispensing systems.

What is claimed is:

1. A liquid storage tank, comprising:
a pressure chamber comprising a liquid space located at a bottom interior portion of the pressure chamber and a vapor space, located at a top interior portion of the pressure chamber;
a liquid bypass riser comprising a first end coupled to the top of the pressure chamber and in communication with the vapor space of the pressure chamber and a second end located exterior to the pressure chamber, the liquid bypass riser forming a first passageway to the vapor space of the pressure chamber for returning liquid to the pressure chamber; and
a vapor return riser located within an interior portion of the liquid bypass riser comprising a first end located in the vapor space of the pressure chamber and a second end located exterior to the pressure chamber, the vapor return riser forming a second passageway to the vapor space of the pressure chamber, the second passageway configured to prevent a liquid in the first passageway from entering the second passageway.

2. The tank of claim 1, wherein the liquid bypass riser comprises a diameter equal to or greater than approximately two inches.

3. The tank of claim 1, wherein the vapor return riser comprises a diameter equal to or greater than approximately one and one quarter inches.

4. The tank of claim 1, wherein the second end of the vapor return riser is coupled to the second end of the liquid bypass riser.

5. The tank of claim 1, further comprising:
a liquid supply riser comprising a first end located in the liquid space of the pressure chamber and a second end located exterior to the pressure chamber, the liquid supply riser forming a passageway from the liquid space of the pressure chamber.

6. The tank of claim 5, wherein the first end of the liquid supply riser comprises a diameter equal to or greater than approximately two inches.

7. The tank of claim 5, wherein the second end of the liquid supply riser comprises a diameter equal to or greater than approximately three inches.

8. The tank of claim 1, wherein the liquid is propane.

9. A liquid dispensing system, comprising:
a liquid storage tank, comprising:
a pressure chamber comprising a liquid space located at a bottom interior portion of the pressure chamber and a vapor space located at a top interior portion of the pressure chamber;
a liquid bypass riser comprising a first end coupled to the top of the pressure chamber and in communication with the vapor space of the pressure chamber and a second end located exterior to the pressure chamber, the liquid bypass riser forming a first passageway to the vapor space of the pressure chamber for returning liquid to the pressure chamber; and
a vapor return riser located within an interior portion of the liquid bypass riser comprising a first end located in the vapor space of the pressure chamber and a second end located exterior to the pressure chamber, the vapor return riser forming a second passageway to the vapor space of the pressure chamber, the second passageway configured to prevent a liquid in the first passageway from entering the second passageway;
a liquid dispenser configured to dispense liquid into an external storage tank;
wherein:
the liquid bypass riser is coupled to a liquid bypass port of the liquid dispenser; and
the vapor return riser is coupled to a vapor return port of the liquid dispenser.

10. The liquid dispensing system of claim 9, wherein the liquid bypass riser comprises a diameter equal to or greater than approximately two inches.

11. The liquid dispensing system of claim 9, wherein the vapor return riser comprises a diameter equal to or greater than approximately one and one quarter inches.

12. The liquid dispensing system of claim 9, wherein the second end of the vapor return riser is coupled to the second end of the liquid bypass riser.

13. The liquid dispensing system of claim 9, the liquid storage tank further comprising a liquid supply riser comprising a first end located in the liquid space of the pressure chamber and a second end located exterior to the pressure chamber, the liquid supply riser forming a passageway from the liquid space of the pressure chamber; and
wherein the liquid supply riser is coupled to a liquid supply inlet port of the liquid dispenser.

14. The liquid dispensing system of claim 13, wherein the first end of the liquid supply riser comprises a diameter equal to or greater than approximately two inches.

15. The liquid dispensing system of claim 13, wherein the second end of the liquid supply riser comprises a diameter equal to or greater than approximately three inches.

16. The liquid dispensing system of claim 15, further comprising a pump configured to pump liquid from the storage tank to the liquid dispenser, the pump comprising a valve, the valve located in an interior portion of the second end of the liquid supply riser.

17. The liquid dispensing system of claim 9, wherein the liquid is propane.

18. The liquid dispensing system of claim 17, wherein the liquid dispenser is a high capacity propane pump.

19. A method for coupling a liquid storage tank to a liquid dispenser, the method comprising:
coupling a liquid bypass riser of the liquid storage tank to a liquid bypass port of the liquid dispenser; and
coupling a vapor return riser of the liquid storage tank to a vapor return port of the liquid dispenser;
wherein:
the liquid storage tank comprises a pressure chamber comprising a liquid space located at a bottom interior portion of the pressure chamber and a vapor space located at a top interior portion of the pressure chamber;
the liquid bypass riser comprises a first end coupled to the top of the pressure chamber and in communication with the vapor space of the pressure chamber and a second end located exterior to the pressure chamber, the liquid bypass riser forming a first passageway to the vapor space of the pressure chamber for returning liquid to the pressure chamber; and
the vapor return riser is located within an interior portion of the liquid bypass riser, the vapor return riser comprising a first end located in the vapor space of the pressure chamber and a second end located exterior to the pressure chamber, the vapor return riser forming a second passageway to the vapor space of the pressure chamber, the second passageway configured to prevent a liquid in the first passageway from entering the second passageway.

20. The method of claim 19, further comprising:
coupling a liquid supply riser to a liquid supply inlet port of the liquid dispenser;
wherein:
the liquid supply riser comprises a first end located in the liquid space of the pressure chamber and a second end located exterior to the pressure chamber, the liquid supply riser forming a passageway from the liquid space of the pressure chamber.
